(19) United States
(12) Patent Application Publication
(10) Pub. No.: US 2026/0170810 A1
(43) Pub. Date: Jun. 18, 2026

(54) APPARATUS AND METHOD FOR BUILDING AN OBJECT DATABASE FOR TRAINING AN ARTIFICIAL INTELLIGENCE MODEL

(71) Applicants: HYUNDAI MOTOR COMPANY, Seoul (KR); KIA CORPORATION, Seoul (KR)

(72) Inventors: Seungha Kim, Hwaseong-si (KR); Byungho Yoon, Hwaseong-si (KR); Jaehoon Joo, Hwaseong-si (KR); Seungyong Lee, Hwaseong-si (KR); Sunkyung Kim, Hwaseong-si (KR); Yongheon Song, Hwaseong-si (KR); Taejune Kim, Hwaseong-si (KR); Jaeho Lee, Hwaseong-si (KR); Hyun Sik Sim, Hwaseong-si (KR)

(73) Assignees: HYUNDAI MOTOR COMPANY, Seoul (KR); KIA CORPORATION, Seoul (KR)

(21) Appl. No.: 19/225,612

(22) Filed: Jun. 2, 2025

(30) Foreign Application Priority Data
Dec. 13, 2024 (KR) 10-2024-0185616

(51) Int. Cl. G06V 10/774; G06V 10/25; G06V 10/26; G06V 10/72; G06V 10/762

(52) U.S. Cl. CPC G06V 10/774; G06V 10/25; G06V 10/26; G06V 10/72; G06V 10/762

(57) ABSTRACT

An apparatus for building an object database for training an artificial intelligence model includes an object photographing module configured to photograph an object by using a monocular camera configured to rotate 360 degrees around the object and obtain 2D images including the object at multiple angles. The apparatus also includes a pre-processing module configured to generate a 3D image with respect to the object based on the 2D images. The apparatus additionally includes an object database generation module configured to generate a dataset including the 3D image with respect to the object and store the generated dataset in the object database.

### CROSS-REFERENCE TO RELATED APPLICATION

This application claims priority to and the benefit of Korean Patent Application No. 10-2024-0185616 filed with the Korean Intellectual Property Office on Dec. 13, 2024, the entire contents of which are hereby incorporated herein by reference.

### BACKGROUND

### (a) Technical Field

The present disclosure relates to an apparatus and method for building an object database for training an artificial intelligence model. More particularly, the present disclosure relates to an apparatus and method for building an object database for training an artificial intelligence model that includes a framework from photographing an object to construct a database.

### (b) Description of the Related Art

In order to achieve high accuracy in developing computer vision algorithms using deep learning, the dataset required for learning is very important. Various methods can be used when obtaining a dataset of an object to be recognized.

For example, methods such as utilizing public datasets, using data crawling methods, using dataset generation tools, generating synthetic data, or utilizing data augmentation can be used to obtain a dataset.

When developing a computer vision algorithm using deep learning, obtaining a dataset of objects to be recognized is a time-consuming and costly bottleneck.

### SUMMARY

In aspects of the present disclosure, an apparatus and method for building an object database for training an artificial intelligence model is provided that conveniently photographs 360-degree images of objects, detects objects, generates an object database, and trains a user-defined model based on the generated object database.

According to an embodiment, an apparatus for building an object database for training an artificial intelligence model is provided. The apparatus includes an object photographing module configured to photograph an object by using a monocular camera configured to rotate 360 degrees around the object and obtain two-dimensional (2D) images including the object at multiple angles. The apparatus also includes a pre-processing module configured to generate a three-dimensional (3D) image with respect to the object based on the 2D images. The apparatus additionally includes an object database generation module configured to generate a dataset including the 3D image with respect to the object and store the generated dataset in the object database.

The apparatus f may further include a model training module configured to provide, to a user, one or more user interfaces (UIs) including one or more of a task selection user interface (UI), a model selection UI, an object selection UI, or a background selection UI. The model training module may also be configured to train a computer vision model, defined by the user via the one or more UIs, using the object database.

The object photographing module may be configured to move the monocular camera around the object as a central axis, by a plurality predetermined angles, and photograph the object by using the monocular camera at each predetermined angle among the plurality of predetermined angles. The object photographing module may be configured to, based on determining that a sum of the plurality of predetermined angles becomes 360 degrees, stop movement and photographing of the monocular camera.

The object photographing module may include a lighting projector configured to change lighting conditions to be different for respective photographs with respect to the object taken at multiple times.

The pre-processing module may be configured to obtain a 3-dimensional structure with respect to a space including the object from the 2D images through a structure-from-motion (SFM) algorithm.

The pre-processing module may be configured to divide the 3D image with respect to the object from the 3-dimensional structure by using an image segmentation algorithm.

The pre-processing module may be configured to scale the 3-dimensional structure, find a region-of-interest in which the object is included, obtain a sample point by clustering feature points disposed in the region-of-interest, obtain an input point by projecting the obtained sample point on each of the 2D images, and generate a mask for the object by inputting the obtained input point into the image segmentation algorithm.

The pre-processing module may be configured to detect a plurality of contours from the generated mask, and remove remaining contours among the plurality of contours excluding a contour that satisfies a preset contour criterion.

The pre-processing module may be configured to, with respect to at least one horizontal axis for which a value obtained by summing a pixel unit mask value for each of a plurality of horizontal axes included in the mask and applying a mean filter to the value satisfies a preset noise criterion, determine the value as a noise and remove the noise.

The object database generation module may be configured to designate a path for the dataset based on the object.

According to another embodiment, a method for building an object database for training an artificial intelligence model is provided. The method includes photographing an object by using a monocular camera configured to rotate 360 degrees around the object and obtaining 2D images including the object at multiple angles. The method also includes generating a 3D image with respect to the object based on the 2D images. The method additionally includes generating a dataset including the 3D image with respect to the object and storing the generated dataset in the object database.

The method may further include training a computer vision model by using the object database, the computer vision model defined by a user via one or more user interfaces (UIs) including one or more of a task selection UI, a model selection UI, object selection UI, or a background selection UI.

Photographing the object may include moving the monocular camera, around the object as a central axis, by a plurality of predetermined angles, photographing the object by using the monocular camera at each predetermined angle among the plurality of predetermined angles, and stopping movement and photographing of the monocular camera based on determining that a sum of the plurality of predetermined angles becomes 360 degrees.

Photographing the object may include controlling a lighting projector configured to illuminate the object and changing lighting conditions to be different for respective photographs with respect to the object taken at multiple times.

Generating the 3D image with respect to the object based on the 2D images may include obtaining a 3-dimensional structure with respect to a space including the object, from the 2D images through a structure-from-motion (SFM) algorithm.

Generating the 3D image with respect to the object based on the 2D images may further include dividing the 3D image with respect to the object from the 3-dimensional structure by using an image segmentation algorithm.

Dividing the 3D image with respect to the object from the 3-dimensional structure by using the image segmentation algorithm includes scaling, by a pre-processing module, the 3-dimensional structure, finding a region-of-interest in which the object is included, obtaining a sample point by clustering feature points disposed in the region-of-interest, obtaining an input point by projecting the obtained sample point on each of the 2D images, and generating a mask for the object by inputting the obtained input point into the image segmentation algorithm.

Generating the 3D image with respect to the object based on the 2D images may further include removing a noise of the mask. Removing the noise of the mask may include detecting a plurality of contours from the mask, and removing remaining contours among the plurality of contours excluding a contour that satisfies a preset contour criterion.

Removing the noise of the mask may further include determining, with respect to at least one horizontal axis for which a value obtained by summing a pixel unit mask value for each of a plurality of horizontal axes included in the mask and applying a mean filter to the summed value satisfies a preset noise criterion, as a noise and removing the noise.

Generating the dataset including the 3D image with respect to the object may include designating a path for the dataset based on the object.

An apparatus and method for building an object database for training an artificial intelligence model according to embodiments may conveniently photograph 360-degree images of objects, detect objects, generate an object database, and train a user-defined model based on the generated object database.

### BRIEF DESCRIPTION OF THE DRAWINGS

FIG. 1 is a schematic flowchart of a method for building an object database for training an artificial intelligence model according to an embodiment.

FIG. 2 is a block diagram of an apparatus for building an object database for training an artificial intelligence model according to an embodiment.

FIG. 3 is a flowchart of a method for building an object database for training an artificial intelligence model according to an embodiment.

FIGS. 4-6 are flowcharts of a method for building an object database for training an artificial intelligence model according to an embodiment.

FIG. 7 is a drawing showing object photographing equipment according to an embodiment.

FIG. 8 is a drawing for explaining a computing device according to an embodiment.

### DETAILED DESCRIPTION

Embodiments of the disclosure are described in more detail hereinafter with reference to the accompanying drawings to enable a person of ordinary skill in the art to implement the present disclosure. As those having ordinary skill in the art should realize, the described embodiments may be modified in various different ways without departing from the spirit or scope of the present disclosure. In order to clarify the present disclosure, parts that are not related to the description have been omitted, and the same elements or equivalents are referred to with the same reference numerals throughout the specification.

In addition, unless explicitly described to the contrary, terms such as “comprise” or “include” and variations such as “comprises,” “comprising,” “includes,” or “including” should be understood to imply the inclusion of stated elements but not the exclusion of any other elements. Terms including an ordinary number, such as first and second, are used for describing various constituent elements, but the constituent elements are not limited by the terms. The terms are only used to distinguish one component from other components.

In addition, the terms “unit”, “part” or “portion”, “-er”, and “module” in the present disclosure refer to a unit that processes at least one function or operation, which may be implemented by hardware, software, or a combination of hardware and software.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, and the like may separately embody or be included with a processor and a memory, such as a non-transitory computer readable media, as part of the apparatus.

Hereinafter, embodiments of the present disclosure are described in detail with reference to the accompanying drawings.

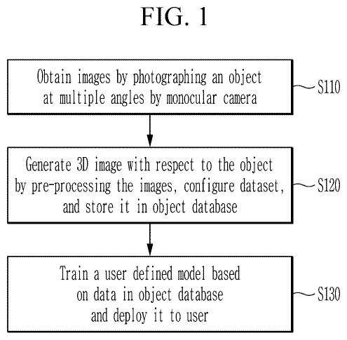

FIG. 1 is a schematic flowchart of a method for building an object database for training an artificial intelligence model according to an embodiment.

The method for building the object database for training an artificial intelligence model may be implemented as a system that may conveniently photograph 360-degree images of the object, construct the image as a database, and train a user-defined computer vision model based on the database.

Referring to FIG. 1, the method for building the object database for training an artificial intelligence model may include a step or operation S110 of obtaining images by photographing the object at multiple angles by using, for example, a monocular camera.

The method for building the object database for training an artificial intelligence model may include a step or operation S120 of generating a three-dimensional (3D) image with respect to the object by pre-processing the images, configuring a dataset, and storing the 3D image in the object database.

The method for building the object database for training an artificial intelligence model may further include a step or operation S130 of training a user-defined model based on data in the object database and providing the trained model to the user.

In an embodiment, the trained model may be used to process image data to perform at least one computer vision task, such as object detection, image recognition, object tracking, etc. based on the image data.

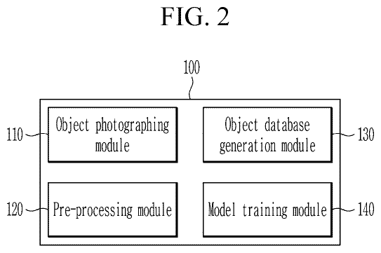

FIG. 2 is a block diagram of an apparatus for building the object database for training an artificial intelligence model according to an embodiment.

Referring to FIG. 2, an apparatus 100 for building the object database for training an artificial intelligence model may include an object photographing module 110, a pre-processing module 120, an object database generation module 130, and a model training module 140.

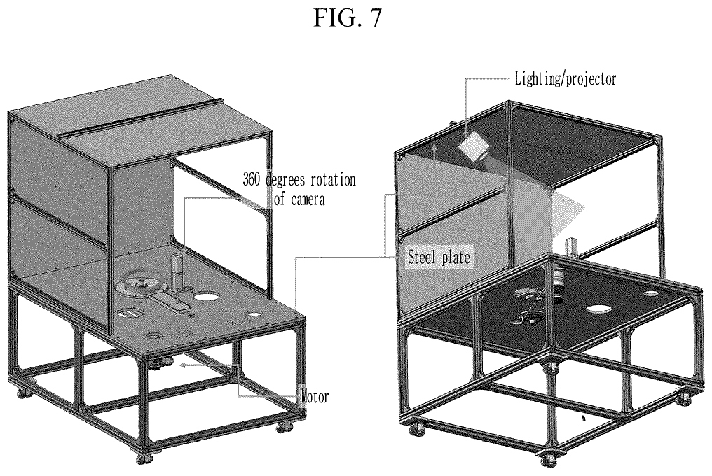

The object photographing module 110 may perform control of the object photographing equipment through a network. Object photographing equipment, according to an embodiment, is described in more detail below with reference to FIG. 7.

The object photographing module 110 may photograph the object by using a monocular camera that rotates 360 degrees around the object, and may obtain 2D images including the object at multiple angles.

The object photographing module 110 may move the monocular camera that rotationally moves 360 degrees around the object as a central axis, multiple times by a predetermined angle at each time.

The object photographing module 110 may photograph the object by using the monocular camera at each predetermined angle. Based on determining that a sum of a plurality of predetermined angles becomes 360 degrees, the object photographing module 110 may stop movement and photographing of the monocular camera.

The object photographing module 110 may include a lighting projector configured to change lighting conditions to be different for respective photographs with respect to the same object of multiple times.

The pre-processing module 120 may generate the 3D image with respect to the object based on the 2D images.

The pre-processing module 120 may obtain a 3-dimensional structure with respect to a space including the object from 2D images through a structure-from-motion (SFM) algorithm.

The pre-processing module 120 may divide the 3D image with respect to the object from the 3-dimensional structure, for example by using the segment anything model (SAM). The 3-dimensional structure may be an entire image including the object. The 3D image with respect to the object may be included within the entire image represented as the 3-dimensional structure.

In more detail, the pre-processing module 120 may scale the 3-dimensional structure.

The pre-processing module 120 may find a region-of-interest in which the object is included.

The pre-processing module 120 may obtain a sample point by clustering feature points disposed in the region-of-interest.

The pre-processing module 120 may project the obtained sample point onto each of 2D images, to obtain an input point.

The pre-processing module 120 may generate a mask for the object by inputting the obtained input point into the segment anything model (SAM).

The pre-processing module 120 may detect a plurality of contours from the generated mask.

The pre-processing module 120 may remove remaining contours among the plurality of contours excluding a contour that satisfies a preset contour criterion. For example, the pre-processing module 120 may remove remaining contours among the plurality of contours excluding a greatest contour.

The pre-processing module 120 may determine, with respect to at least one horizontal axis for which a value obtained by summing a pixel unit mask value for each of a plurality of horizontal axes included in the mask and applying a mean filter to the summed value satisfies (e.g., is smaller than or equal to) a preset noise criterion, as a noise and remove the noise.

The object database generation module 130 may generate a dataset including the 3D image with respect to the object and may store the generated dataset in the object database.

The object database generation module 130 may designate a path for the dataset based on the object.

The object database generation module 130 may train a user definition-based computer vision model by using the object database.

The model training module 140 may provide a plurality of UIs including a task selection user interface (UI), a model selection UI, an object selection UI, and a background selection UI to the user through the web or application.

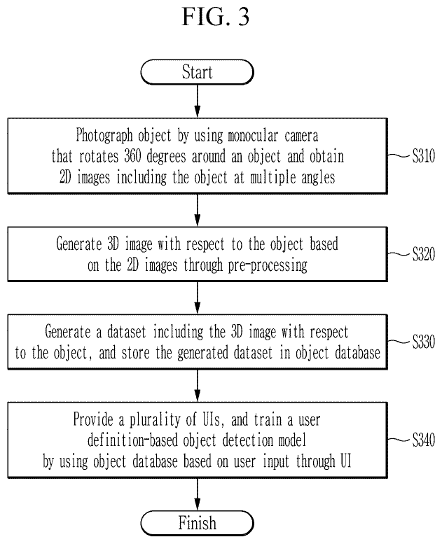

FIG. 3 is a flowchart of a method for building the object database for training an artificial intelligence model according to an embodiment. The method for building the object database for training an artificial intelligence model of FIG. 3 may be performed by the apparatus 100 of FIG. 2, in an embodiment.

In FIG. 3, at a step or operation S310, the apparatus 100 may photograph the object by using a monocular camera that rotates 360 degrees around the object and obtain 2D images including the object at multiple angles.

The apparatus 100 may move the monocular camera that rotationally moves 360 degrees around the object as a central axis, multiple times by the predetermined angle at each time, and may photograph the object at each predetermined angle.

When a sum of the plurality of predetermined angles becomes 360 degrees, the apparatus 100 may stop movement and photographing of the monocular camera.

The apparatus 100 may control the lighting projector configured to illuminate the object and may change lighting conditions to be different for respective photographs with respect to the same object of multiple times.

At a step or operation S320, the apparatus 100 may generate the 3D image with respect to the object based on the 2D images through a pre-processing.

At the step or operation S320, the apparatus 100 may perform scaling, a masking algorithm, and a mask noise removal algorithm with respect to the object through a pre-processing pipeline prepared for each object.

The apparatus 100 may obtain the 3-dimensional structure with respect to a space including the object from 2D images through a structure-from-motion (SFM) algorithm.

The apparatus 100 may divide the 3D image with respect to the object from the 3-dimensional structure, for example by using the segment anything model (SAM).

In order to divide the 3D image with respect to the object by using the segment anything model (SAM), the apparatus 100 may scale the obtained 3-dimensional structure.

Thereafter, the apparatus 100 may detect the region-of-interest in which the object is included.

In addition, the apparatus 100 may obtain the sample point by clustering feature points disposed in the region-of-interest.

The apparatus 100 may project the obtained sample point onto each of 2D images, to obtain the input point.

The apparatus 100 may generate the mask for the object by finally inputting the obtained input point into the segment anything model (SAM). The generated mask may include the divided 3D image with respect to the object.

Thereafter, the apparatus 100 may remove the noise of the mask.

The apparatus 100 may detect the plurality of contours from the mask and may remove remaining contours among the plurality of contours excluding a contour that satisfies a preset contour criterion (e.g., the greatest contour).

The apparatus 100 may sum the pixel unit mask value for each of the plurality of horizontal axes included in the mask.

With respect to at least one horizontal axis for which the value obtained by applying the mean filter to the summed value satisfies (e.g., is smaller than or equal to) a preset noise criterion, the apparatus 100 may determine the value as noise and may remove the noise.

At a step or operation S330, the apparatus 100 may generate a dataset including the 3D image with respect to the object and may store the generated dataset in the object database.

At the step or operation S330, the apparatus 100 may designate a path for the dataset based on the object.

At a step or operation S340, the apparatus 100 may provide the plurality of UIs and may train the user definition-based computer vision model by using the object database based on user input through the UI.

The apparatus 100 may provide a web-based machine learning operations (MLOps) platform to the user. MLOps may include a set of practices and tools for deploying machine learning (ML) models into production environments and efficiently managing them throughout their lifecycle.

The MLOps may be an automated machine-learning pipeline that automates the ML workflow from data preprocessing to model training and deployment, thereby increasing speed, reducing manual errors, and making the process repeatable and scalable.

The apparatus 100 may comprise a web-based MLOps platform that may provide a user interface (UI) capable of setting the learning model and data to the user.

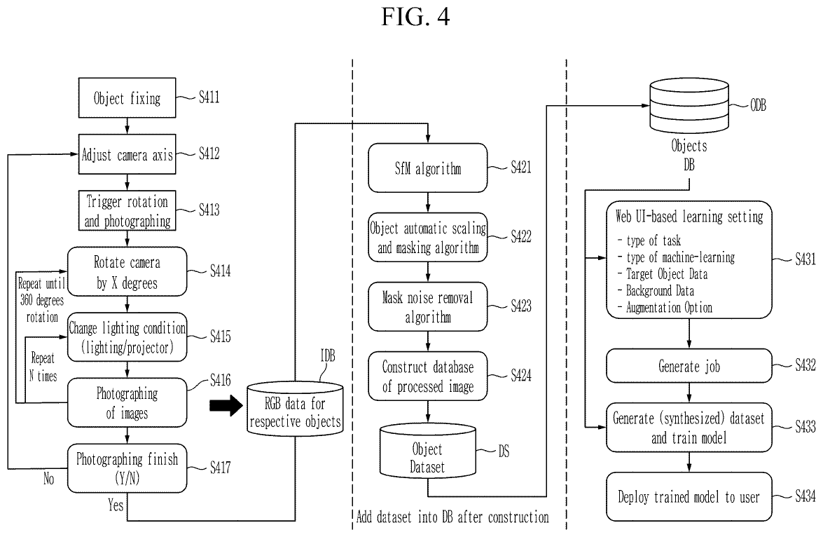

FIGS. 4-6 are flowcharts of a method for building an object database for training an artificial intelligence model according to an embodiment. The method for building the object database for training an artificial intelligence model may be performed by the apparatus 100 of FIG. 2, according to an embodiment.

FIG. 4 shows a system diagram of the method for building the object database for training an artificial intelligence model. FIG. 4 is a flowchart specifically showing steps or operations of FIG. 1 according to an embodiment.

Referring to FIG. 4, at steps or operations S411-S417, the apparatus 100 may obtain images by photographing the object at multiple angles by using a monocular camera.

At the step or operation S411, the apparatus 100 may fix the object to be photographed to the photographing equipment. In this example, the photographing equipment may include the object fixing equipment and a camera equipment.

The apparatus 100 may control the photographing equipment through a network.

At the step or operation S412, the apparatus 100 may adjust the axis of the camera disposed around the fixed object.

At the step or operation S413, the apparatus 100 may rotate the camera around the object and at the same time photograph the object.

At the step or operation S414, the apparatus 100 may rotate the camera by the predetermined angle (X degrees) around the fixed object as a center.

At the step or operation S415, before photographing the object through the camera rotated by the predetermined angle, the apparatus 100 may change the lighting condition for illuminating the object.

At the step or operation S416, the apparatus 100 may photograph the object at the rotated angle under the specific lighting condition.

At the step or operation S415, the apparatus 100 may photograph the object by repeating the steps or operations S414-S416, and when the camera rotates 360 degrees from an initial angle, may stop the repetition.

At the step or operation S417, the apparatus 100 may finish the photographing when the image photographing is completed, and when it is determined that the image photographing has not been completed (“No” at step S417), may continue to photograph by adjusting the camera axis.

Accordingly, the apparatus 100 may determine whether the photographing has been completed based on the photographing results, and when it is determined that the camera axis needs to be adjusted, may perform steps or operations S412-S417 again, without finishing the photographing.

When it is determined that the photographing has been completed (“Yes” at step S417), the apparatus 100 may store the 2D image data with respect to the object in the RGB database (IDB) for each object.

At steps or operations S421-S424, the apparatus 100 may generate the 3D image with respect to the object by pre-processing the images, may configure the dataset, and may store the dataset in the object database.

The apparatus 100 may obtain the 3-dimensional structure based on 2D images with respect to the object and the object space obtained according to the photographing results.

At the step or operation S421, the apparatus 100 may calculate coordinates of 3-dimensional points matched with the camera positions by using an SFM algorithm with respect to the space photographing results of the object.

By using the SFM algorithm, the apparatus 100 may find points at the same location in the overlapping portion of images obtained by photographing by changing the location of the camera with respect to one space.

In addition, the apparatus 100 may calculate a geometric relationship between two images by using the matched points.

Thereafter, the apparatus 100 may optimize the overall triangulate 3D points and the camera parameters through the Bundle Adjustment process.

As a result, the apparatus 100 may obtain the coordinates of 3D points matched with the camera positions with respect to the object.

At the step or operation S422, the apparatus 100 may scale the object and may perform masking algorithm.

At the step or operation S423, the apparatus 100 may remove noise using the noise removal algorithm with respect to the obtained mask.

At the step or operation S424, the apparatus 100 may generate a dataset DS of the mask and the image that have been processed for the noise, and may store the dataset DS in the object database DS, thereby constructing the database.

At steps or operations S431-S434, the apparatus 100 may train the user-defined model based on data in the object database and may deploy the trained model to the user.

At the step or operation S431, the apparatus 100 may provide a web-based model learning setting UI to the user.

The apparatus 100 may provide user with a UI enabling the user to select the type of task, the type of machine-learning model, the object data, the background data, and a data augmentation option.

The apparatus 100 may set the task and the model and combine the object dataset (object and background) stored in the database, to train the user-defined model.

At the step or operation S432, the apparatus 100 may generate a job in the unit of a container in an environment capable of training the model set to the GPU cluster by using Kubernetes, or the like and deploy the generated job to a GPU server.

At the step or operation S433, the apparatus 100 may generate a dataset having an option for the database and augmentation set inside the generated container, and performing training.

In the case of the object detection and instance segmentation, the apparatus 100 may perform training based on a 2-dimension synthesis dataset.

At the step or operation S434, the apparatus 100 may deploy the trained model to the user through the web.

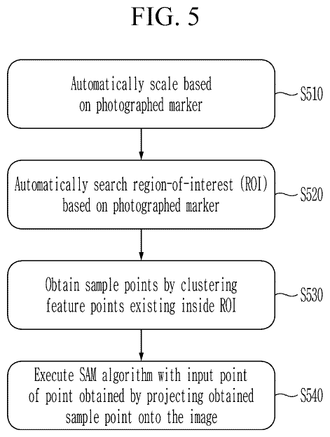

FIG. 5 is a flowchart specifically showing the object scaling and masking algorithm for pre-processing, according to an embodiment.

Referring to FIG. 5, at a step or operation S510, the apparatus 100 may perform marker-based scaling.

In an embodiment, the apparatus 100 may monitor the load of a workload in a cloud environment or a container orchestration system, and when a specific criterion (e.g., a marker) is met, may perform the scaling operation. In one example, the scaling may be performed automatically when the specific criterion is met.

The marker may be a specific indicator to be monitored by the system in order to determine scaling, and may be predetermined or user-defined.

At a step or operation S520, the apparatus 100 may search the region-of-interest (ROI) based on the photographed marker. In an example, the ROI may be searched automatically based on the photographed marker.

At a step or operation S530, the apparatus 100 may obtain the sample point by clustering feature points existing inside the region-of-interest.

The region-of-interest may be a region where the object is included, and the feature points may include a central point of the object, or the like. The sample point may be a central point of the cluster or a most representative one among feature points within the cluster.

At a step or operation S540, the apparatus 100 may execute a SAM algorithm with an input value of a point obtained by projecting the obtained sample point onto the image.

Accordingly, the apparatus 100 may provide 2D coordinates of the sample point projected on the image as the input value of SAM.

The apparatus 100 may generate the mask by dividing the region with a center at the designated coordinate point location. The generated mask may include a portion corresponding to the region-of-interest in the image.

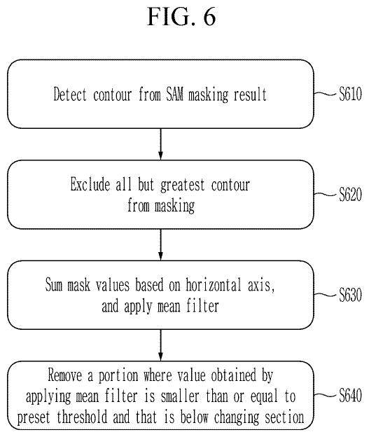

FIG. 6 is a flowchart showing the noise removal algorithm of the object mask, according to an embodiment.

Referring to FIG. 6, at a step or operation S610, the apparatus 100 may detect a contour from the SAM masking result.

At a step or operation S620, the apparatus 100 may exclude remainders, except for a contour that satisfies a preset contour criterion (e.g., the greatest contour), from the masking.

At a step or operation S630, the apparatus 100 may sum the mask values based on the horizontal axis, and may apply the mean filter.

At a step S640, the apparatus 100 may remove a portion where the value obtained by applying the mean filter is smaller than or equal to a predetermined threshold value, and that is below a changing section, as noise.

FIG. 7 is a drawing showing object photographing equipment according to an embodiment. FIG. 7 shows a mechanical part of the object photographing equipment according to an embodiment. The mechanical part may be controlled by the apparatus 100 of FIG. 2, according to an embodiment.

Accordingly, the apparatus 100 may photograph the object by controlling the object photographing equipment.

The mechanical part of the object photographing equipment may include, at a fixing portion for fixing the object, the camera configured to rotate 360 degrees around the object, a steel plate for fixing the camera, a motor configured to rotate the camera fixed to the steel plate, and a lighting/projector.

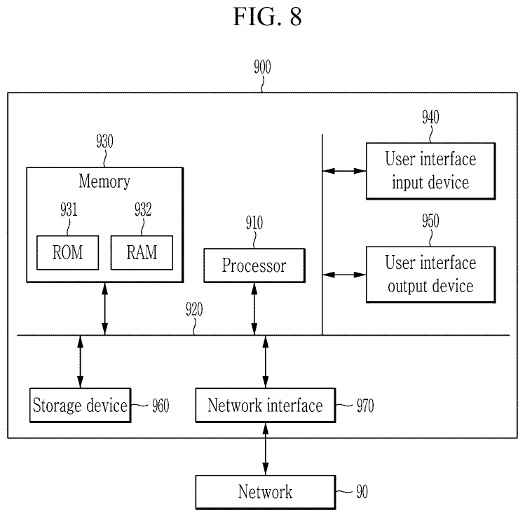

FIG. 8 is a drawing for explaining a computing device according to an embodiment.

Referring to FIG. 8, an apparatus and method for building the object database for training an artificial intelligence model according to embodiments may be implemented by using a computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIGS. 1-7.

The memory 930 and the storage device 960 may include various types of volatile or non-volatile storage media. For example, the memory may include read-only memory (ROM) 931 and a random-access memory (RAM) 932. In this embodiment, the memory 930 may be located inside or outside processor 910, and the memory 930 may be connected to the processor 910 through various known means.

In some embodiments, at least some configurations or functions of an apparatus and method for building an object database for training an artificial intelligence model according to an embodiment may be implemented as a program or software executable by the computing device 900, and program or software may be stored in a computer-readable medium.

In some embodiments, at least some configurations or functions of an apparatus and method for building an object database for training an artificial intelligence model according to an embodiment may be implemented by using hardware or circuitry of the computing device 900, or may also be implemented as separate hardware or circuitry that may be electrically connected to the computing device 900.

While this disclosure has been described in connection with what is presently considered to be practical embodiments, it should be understood that the disclosure is not limited to the disclosed embodiments. Rather, the present disclosure is intended to cover various modifications and equivalent arrangements included within the spirit and scope of the appended claims.

What is claimed is:

1. An apparatus for building an object database for training an artificial intelligence model, the apparatus comprising:
an object photographing module configured to photograph an object by using a monocular camera configured to rotate 360 degrees around an object and obtain two-dimensional (2D) images comprising the object at multiple angles;
a pre-processing module configured to generate a three-dimensional (3D) image with respect to the object based on the 2D images; and
an object database generation module configured to generate a dataset comprising the 3D image with respect to the object and store the dataset in the object database.

2. The apparatus of claim 1, further comprising a model training module configured to:
provide, to a user, one or more user interfaces (UIs) including one or more of a task selection UI, a model selection UI, an object selection UI, or a background selection UI; and
train a computer vision model, defined by the user via the one or more UIs, using the object database.

3. The apparatus of claim 1, wherein the object photographing module is configured to:
move the monocular camera, around the object as a central axis, by a plurality of predetermined angles;
photograph the object by using the monocular camera at each predetermined angle among the plurality of predetermined angles; and
based on determining that a sum of the plurality of predetermined angles becomes 360 degrees, stop movement and photographing of the monocular camera.

4. The apparatus of claim 1, wherein the object photographing module comprises a lighting projector configured to change lighting conditions to be different for respective photographs of the object taken at multiple times.

5. The apparatus of claim 1, wherein the pre-processing module is configured to obtain a 3-dimensional structure with respect to a space comprising the object from the 2D images through a structure-from-motion (SFM) algorithm.

6. The apparatus of claim 5, wherein the pre-processing module is configured to divide the 3D image with respect to the object from the 3-dimensional structure by using an image segmentation algorithm.

7. The apparatus of claim 6, wherein the pre-processing module is configured to:
scale the 3-dimensional structure;
find a region-of-interest in which the object is comprised;
obtain a sample point by clustering feature points disposed in the region-of-interest;
obtain an input point by projecting the obtained sample point on each of the 2D images; and
generate a mask for the object by inputting the obtained input point into the image segmentation algorithm.

8. The apparatus of claim 7, wherein the pre-processing module is configured to:
detect a plurality of contours from the generated mask; and
remove remaining contours among the plurality of contours excluding a contour that satisfies a preset contour criterion.

9. The apparatus of claim 8, wherein the pre-processing module is configured to, with respect to at least one horizontal axis for which a value obtained by summing a pixel unit mask value for each of a plurality of horizontal axes comprised in the mask and applying a mean filter to the value satisfies a preset noise criterion, determine the value as a noise and remove the noise.

10. The apparatus of claim 1, wherein the object database generation module is configured to designate a path for the dataset based on the object.

11. A method for building an object database for training an artificial intelligence model, comprising:
photographing an object by using a monocular camera configured to rotate 360 degrees around the object and obtaining two-dimensional (2D) images comprising the object at multiple angles;
generating a three-dimensional (3D) image with respect to the object based on the 2D images;
generating a dataset comprising the 3D image with respect to the object; and
storing the generated dataset in the object database.

12. The method of claim 11, further comprising training a user definition-based computer vision model by using the object database based on a user input obtained via one or more user interfaces (UIs) including one or more of a task selection UI, a model selection UI, object selection UI, or a background selection UI.

13. The method of claim 11, wherein photographing the object by using the monocular camera includes:
moving the monocular camera, around the object as a central axis, by a plurality of predetermined angles;
photographing the object by using the monocular camera at each predetermined angle among the plurality of predetermined angles; and
stopping movement and photographing of the monocular camera based on determining that a sum of the plurality of predetermined angles becomes 360 degrees.

14. The method of claim 11, wherein photographing the object by using the monocular camera includes controlling a lighting projector configured to illuminate the object to change lighting conditions to be different for respective photographs with respect to the object taken at multiple times.

15. The method of claim 11, wherein generating the 3D image with respect to the object based on the 2D images includes obtaining 3-dimensional structure with respect to a space comprising the object from the 2D images through a structure-from-motion (SFM) algorithm.

16. The method of claim 15, wherein generating the 3D image with respect to the object based on the 2D images further includes dividing the 3D image with respect to the object from the 3-dimensional structure by using an image segmentation algorithm.

17. The method of claim 16, wherein dividing the 3D image with respect to the object from the 3-dimensional structure by using the image segmentation algorithm includes:
scaling, by a pre-processing module, the 3-dimensional structure;
finding a region-of-interest in which the object is comprised;
obtaining a sample point by clustering feature points disposed in the region-of-interest;
obtaining an input point by projecting the obtained sample point on each of the 2D images; and
generating a mask for the object by inputting the obtained input point into the image segmentation algorithm.

18. The method of claim 17, wherein generating the 3D image with respect to the object based on the 2D images further includes removing a noise of the mask, wherein removing the noise of the mask includes detecting a plurality of contours from the mask and removing remaining contours among the plurality of contours excluding a contour that satisfies a preset contour criterion.

19. The method of claim 18, wherein removing the noise of the mask further includes determining, with respect to at least one horizontal axis for which a value obtained by summing a pixel unit mask value for each of a plurality of horizontal axes comprised in the mask and applying a mean filter to the value satisfies a preset noise criterion, as a noise and removing the noise.

20. The method of claim 11, wherein generating the dataset comprising the 3D image with respect to the object includes designating a path for the dataset based on the object.
